(19) United States
(12) Patent Application Publication
(10) Pub. No.: US 2022/0319265 A1
(43) Pub. Date: Oct. 6, 2022

(54) COMPUTER PROGRAM, NON-TRANSITORY MACHINE-READABLE MEDIUM, APPARATUS, AND METHODS FOR ELECTRONIC ELECTION

(71) Applicant: Sony Group Corporation, Tokyo (JP)

(72) Inventors: Oleksandr VOLOSHKO, Stuttgart (DE); Tomasz KORWIN-GAJKOWSKI, Stuttgart (DE); Michele MINELLI, Stuttgart (DE)

(73) Assignee: Sony Group Corporation, Tokyo (JP)

(21) Appl. No.: 17/702,788

(22) Filed: Mar. 24, 2022

(30) Foreign Application Priority Data
Mar. 31, 2021 (EP) 21166262.2

(51) Int. Cl. G07C 13/00; H04L 9/08

(52) U.S. Cl. CPC G07C 13/00; H04L 9/0869; H04L 2209/38

(57) ABSTRACT

Embodiments of the present disclosure provide a computer program, a non-transitory machine-readable medium, an apparatus, and methods for electronic election. In particular, embodiments provide a method for electronic election, the method comprising generating, by a trusted execution environment (TEE), a symmetric key for at least one user and based on a seed. Also, the method comprises providing, by the TEE, the symmetric key to a first data processing circuit of the user for encrypting the user's vote with the symmetric key and entering the encrypted vote in a distributed ledger database. Further, the method comprises providing, by the TEE, the seed to at least one second data processing circuit and obtaining, by the second data processing circuit, the user's vote from the distributed ledger database using the seed.

### CROSS-REFERENCE TO RELATED APPLICATION

This application claims priority from EP 21166262.2, filed on Mar. 31, 2021, the entire contents of which are incorporated herein by reference.

### FIELD

Embodiments of the present disclosure relate to a computer program, a non-transitory machine-readable medium, an apparatus, and methods for electronic election. In particular, embodiments relate to a concept for establishing and evaluating an electronic election.

### BACKGROUND

Electronic elections play an increasingly important role in information technology and other related technical fields. Electronic elections can be used for political elections, but also for private and other purposes. Compared to traditional concepts using paper ballots for elections, electronic election provides faster data processing. Known concepts for electronic elections provide for a single authorized entity capable of distributing of electronic ballots to voters, collecting filled ballots from the voters, and evaluating the electronic election, thereby lacking transparency.

Hence, there may be a demand for an improved concept for electronic election.

### SUMMARY

This demand may be satisfied by the subject-matter of the appended independent and dependent claims.

Embodiments of the present disclosure provide a method for electronic election. The method comprises generating, by a trusted execution environment (TEE), a symmetric key for at least one user and based on a seed. Also, the method comprises providing, by the TEE, the symmetric key to a first data processing circuit of the user for encrypting the user's vote with the symmetric key and entering the encrypted vote in a distributed ledger database. Further, the method comprises providing, by the TEE, the seed to at least one second data processing circuit and obtaining, by the second data processing circuit, the user's vote from the distributed ledger database using the seed.

In context of the present disclosure, the electronic election can be any form of an organized choice by one or multiple persons (voters). So, the electronic election may refer to political elections but also to any form of private, or commercial elections, polls, or surveys. The user can be understood as a voter participating in the electronic election.

The TEE can be understood as an isolated execution environment which provides security features such as isolated execution, integrity of applications/functions/routines/code executed by the TEE, along with confidentiality of their assets. Also, the TEE may provide remote attestation to reveal tampering of the TEE. In this way, the TEE provides a secure generation of the symmetric key based on the seed. The TEE generating the symmetric key, e.g., runs on a server separate from the first and/or the second data processing circuit. The first data processing circuit, e.g., is a personal user device (e.g. a mobile phone, a tablet, a personal computer, etc.) or a public polling terminal (e.g. a public computer) configured to receive the user's vote, encrypt the vote using the symmetric key for secrecy-preservation, and enter the encrypted vote to the distributed ledger database, thereby providing that the entered encrypted vote is stored in a tamper-evident and secret way. The distributed ledger database, e.g., is a blockchain or a so-called “non-blockchain distributed ledger”.

In accordance with the underlying principle of symmetric encryption, the symmetric key is to be understood as a symmetric key which can decrypt data encrypted with the same symmetric key. In context of the present disclosure, the symmetric key, e.g., is configured to decrypt the vote encrypted with the (same) symmetric key. The symmetric key may be configured for the use with one of various types of symmetric-key algorithms (e.g. in accordance with the Advanced Encryption Standard, AES, Twofish, Serpent, etc.). The seed can be a number, a vector, or of another type of data. For generating the symmetric key, the seed, e.g. is used as input to a key generation algorithm. So, the seed can be understood as an initial condition on which the symmetric key is generated. The seed can be also referred to as “random seed” or “seed state”. The key generation algorithm, e.g., is a (deterministic) pseudorandom number generator configured to reproduce the same symmetric key for the same seed. So, the seed enables the second data processing circuit to obtain the user's vote e.g., in order to determine or verify a result of the electronic election and in favor of transparency of the electronic election. In particular, the seed enables the second data processing circuit to track or reconstruct how the user voted, i.e. for whom or what the user has voted. For this, the second data processing circuit may reproduce the symmetric key of the user and use the symmetric key to obtain the user's vote.

According to a basic idea of the present disclosure, the seed can be shared with a data processing circuit of any entity, here the second data processing circuit, which should be enabled to have insight into the electronic election, e.g., to determine or verify the result, or to check the electronic election for election fraud, and in favor of transparency of the electronic election.

In practice, multiple users may participate in the electronic election and the above method involves the multiple users.

Embodiments also provide a method for setting up an electronic election. The method comprises generating, for at least one user, using a TEE, and based on a seed, a symmetric key for encrypting the user's vote with the symmetric key and for entering the encrypted vote in a distributed ledger database. Further, the method comprises providing the symmetric key to a first data processing circuit of the user. Also, the method comprises providing the seed to at least one second data processing circuit and for obtaining the user's vote from the distributed ledger database by the second data processing circuit using the seed.

Other embodiments provide a method for evaluating an electronic election. The method comprises receiving a seed for generating a symmetric key for at least one user based on the seed for voting. Further, the method comprises obtaining, using the seed, the user's vote from a distributed ledger database. The user's vote is stored as an encrypted vote encrypted with the symmetric key in the distributed ledger database.

Further embodiments provide a computer program having a program code for performing an embodiment of the proposed methods when the program is executed on a processor or a programmable hardware. Also, embodiments provide a non-transitory machine-readable medium having stored thereon such a computer program.

Embodiments also provide an apparatus for electronic election. The apparatus comprises one or more interfaces for communicating and a processing circuitry configured to control the one or more interfaces. The processing circuitry and the one or more interfaces are configured to carry out an embodiment of any of the proposed methods.

### BRIEF DESCRIPTION OF THE FIGURES

Some examples of apparatuses and/or methods will be described in the following by way of example only, and with reference to the accompanying figures, in which

FIG. 1 shows a flow chart schematically illustrating an embodiment of a method for electronic election;

FIG. 2 shows a flow chart schematically illustrating an embodiment of a method for setting up an electronic election;

FIG. 3 shows a flow chart schematically illustrating an embodiment of a method for evaluating an electronic election;

FIG. 4 shows a block diagram schematically illustrating an apparatus for electronic election; and

FIG. 5 shows a block diagram schematically illustrating an application of the proposed concept.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

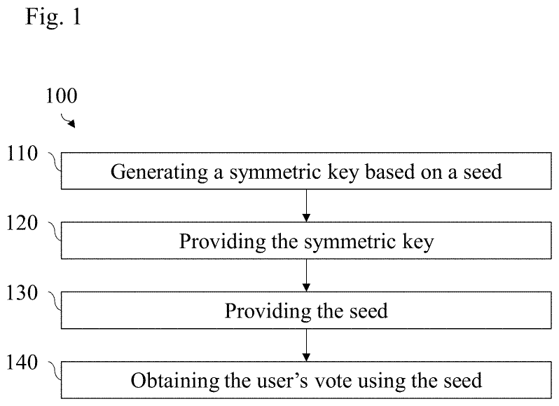

FIG. 1 shows a flow chart schematically illustrating an embodiment of a method 100 for electronic election.

As can be seen from the flow chart, method 100 comprises generating 110, by a trusted execution environment (TEE), a symmetric key for at least one user and based on a seed. For generating 110 the symmetric key, a key generation algorithm for generating the symmetric key may be used and the seed may be used as input to the key generation algorithm. The key generation algorithm can be one of various deterministic cryptographic hash functions, e.g., one of the Secure Hash Algorithms 2 or 3 (SHA 2/3). As already mentioned above, the seed may be a number, a vector, or other data to be used as an initial condition for generating the symmetric key. In particular, the seed may be kept secret to avoid that unauthorized entities know the seed and manipulate the electronic election using the seed. In order to keep the seed secret, it may be generated specifically for the electronic election and stored securely. In order to do so, the seed, e.g. is generated and/or stored in the TEE. One way to generate the seed is to use a pseudorandom number generator (PRNG), in particular a cryptographically secure PRNG (CSPRNG).

The TEE may run on a separate server for establishing the electronic election and, e.g. in parallel with a rich operating system of the server, and may provide various security features in order to provide a higher level of security for generating the symmetric key than the rich operating system. The use of the TEE may prevent the symmetric key from being illegitimately retrieved, e.g., for fraudulent purposes.

In order to determine by the symmetric key if the user voted multiple times and to dispense with a digital signature of the vote by the user, the user may be provided with an individual (unique) symmetric key. For this, generating 110 the symmetric key may comprise obtaining information related to the user and generating an individual symmetric key for the user based on the information related to the user. In order to preserve the user's privacy, the information related to the user may be indicative of a (arbitrary or pseudorandom) number, string, or other anonymous data.

It is noted that although method 100 is mainly described in connection with a single user, it may be also applied to multiple users.

For multiple users, accordingly, an individual symmetric key s(i)=sha256(seed+i) may be provided to the i-th user, wherein sha256 denotes the SHA-256 symmetric-key algorithm and i denotes a number for the use as information related to a respective user.

Another approach for providing symmetric keys to multiple users is to provide the j-th of managing servers configured to distribute the symmetric keys to a respective portion of the users with an individual superordinate symmetric key x(j)=sha256(seed+j) for the respective portion of users of the j-th managing server, wherein j denotes a number for the use as information related to a respective managing server. In turn, the j-th managing server may then provide the i-th user of the portion of users with an individual symmetric key s(i)=sha256(x(j)+i). In doing so, the j-th managing server is solely provided with x(j) such that the j-the managing server is not aware of individual superordinate symmetric keys of other managing servers. In this way, it is avoided that managing servers can fake symmetric keys of users of other managing servers.

As stated later in more detail, the generation of the symmetric key based on the seed allows to provide transparency of the electronic election by issuing the seed. When using i and/or j for generating the symmetric key, they may be also issued together with the seed in order to enable that the votes of the users are obtained using i and/or j.

Further, method 100 comprises providing 120, by the TEE, the symmetric key to a first data processing circuit of the user for encrypting the user's vote with the symmetric key for secrecy-preservation and entering the encrypted vote in a distributed ledger database. The first data processing circuit, e.g., is a personal user device or a public polling terminal to be used by multiple users/voters. For providing 120 the symmetric key to the first data processing circuit, e.g., the TEE sends the symmetric key via a one or more communication networks (e.g. wireless, cellular, and/or local networks) to the first data processing circuit. The use of the TEE may prevent the symmetric key from being addressed and sent to illegitimate recipients, e.g., due to any tampering. Optionally, also other measures are taken to avoid that illegitimate recipients receive the symmetric key. In practice, optionally secure communication channels may be used for providing 120 the symmetric key to the first data processing circuit and/or the symmetric key may be encrypted. For example, the symmetric key may be encrypted with a public key of the user or the first data processing circuit having a suitable private key for decrypting the symmetric key encrypted with said public key.

The user's vote can be understood as data or information indicating a choice or input of the user in the electronic election. In other words, the vote indicates how the user voted. In some embodiments, the user's vote may be embedded in an electronic ballot. For encrypting the vote, the first data processing circuit may run a symmetric-key algorithm using the symmetric key for encrypting the vote or the electronic ballot containing the user's vote. So, the encrypted vote, e.g., comprises or corresponds to a hash or a cipher based on the symmetric key and the user's vote.

For entering the encrypted vote in a distributed ledger database, the first data processing circuit itself may record the encrypted vote in the distributed ledger database. Alternatively, an intermediate data processing circuit may relay the encrypted vote and record the encrypted vote in the distributed ledger database. The distributed ledger database can be understood as a decentralized and synchronized database which is shared between multiple entities, e.g., multiple servers, computers, and/or data processing circuits. This allows to ensure that the encrypted vote stored in the distributed ledger database is not changed or manipulated afterwards, e.g., in order to manipulate the electronic election. In practice, the distributed ledger database may comprise or correspond to a blockchain. Optionally, the distributed ledger database may comprise or correspond to a so-called “non-blockchain distributed ledger database”. One option to enter the encrypted vote in the distributed ledger database is to directly enter a respective hash or cipher of the encrypted vote in an entry of the distributed ledger database. Another option to enter the encrypted vote is to enter the hash or cipher of the encrypted vote in a hash tree whose hash root which is then indicative of the encrypted vote is entered in an entry of the distributed ledger database. In this way multiple encrypted votes can be represented by a dedicated common entry, e.g., in order to store multiple votes of multiple user/voters in a more storage saving way.

Since the user's vote stored in the blockchain is encrypted, it is prevented from being revealed by an entity unaware of the symmetric key.

Method 100 also comprises providing 130, by the TEE, the seed to at least one second data processing circuit, e.g. in order to enable the second data processing circuit to determine or verify a result of the electronic election. The second data processing circuit, e.g., is a specific data processing circuit for evaluating and/or verifying the electronic election. Optionally, the second data processing circuit belongs to a participant, e.g., a voter or a party up for election, of the electronic election who shall be enabled to determine and/or verify the result. In practice, providing 130 the seed to the second data processing circuit may comprise publishing the seed, thereby providing the seed to the second data processing circuit as well as to one or more other data processing circuits which shall be enabled to evaluate and/or verify the electronic election.

Further, method 100 comprises obtaining 140, by the second data processing circuit, the user's vote from the distributed ledger database using the seed. For this, the second data processing circuit may use the seed to reproduce or reconstruct the symmetric key and use the symmetric key to obtain the user's vote. For this purpose, the reproduced symmetric key can be used to iterate through entries of the distributed ledger database and find an entry comprising or corresponding to the user's vote encrypted with the same symmetric key. In order to do so, one optional approach to find this entry is to test which of the entries is decipherable by the reproduced symmetric key. According to another, more efficient approach, obtaining 140 the user's vote may comprise reproducing the symmetric key using the seed, generating, using the reproduced symmetric key, data structures for one or more potential encrypted votes of the user, and comparing the data structures with the distributed ledger database for obtaining the user's vote from one of the data structures which matches with the encrypted vote. Optionally, also i and/or j are/is received and used to determine the symmetric key in accordance with the above described routine for generating the symmetric key. The potential encrypted votes, e.g., are indicative of potential votes (e.g. indicative of potential different choices, options, parties) of the user. So, in order to generate the data structures, all the potential votes may be obtained and used to generate the data structures. The (actual) vote of the user, then may be obtained (in an unciphered form) by the potential vote used for generating the data structure matching with the encrypted vote.

Either way, through the above outlined generation of the symmetric key based on the seed and the symmetric encryption, method 100 enables entities and/or devices, here the second data processing circuit, receiving the seed, and having access to the distributed ledger database to reconstruct the user's voting for verification and, thus, transparency vis-á-vis said entities. In particular, embodiments of method 100 may comprise evaluating the electronic election using the obtained vote.

In order to avoid that the user's vote is obtained before it is desired or allowed, the seed may be provided to the second data processing circuit after lapse of a predetermined time. The predetermined time, e.g., is a time when the electronic election is closed for voting such that the user's vote is not obtained before the electronic election is closed and election agreements and/or frauds are avoided.

In some embodiments, a time stamp indicative of a time when the user voted may be entered in the distributed ledger database. Respectively, the distributed ledger database may store a timestamp indicating a time when the user submitted the vote and method 100 may further comprise obtaining the timestamp from the distributed ledger database and checking whether the user submitted the vote within a predefined time slot. The predefined timeslot, e.g., is a timeslot within which the user can validly vote. In other words, the timeslot may be a timeslot outside of which votes of the user are invalid. So, the timeslot can be a time within which the electronic election is “open” for voting. So, checking the timestamp, e.g., allows to determine whether the user voted validly while the electronic election was open for voting or invalidly while the electronic election was closed.

In practice, the electronic election may involve multiple users being voters and the method 100 may be applied for the multiple users. Accordingly, the seed may be used to generate multiple individual symmetric keys for the users and provide each of the users with a respective individual symmetric key. So, the users may encrypt their individual votes with their respective individual key and enter the encrypted votes in the distributed ledger database. For verification, ergo, the vote of each of the users may be obtained in the way described herein. Thus, the electronic election can be reconstructed in order to determine or verify a result of the electronic election, e.g., to evaluate the electronic election or to verify a number of votes for specific choices, options, and/or parties which have been up for election.

Some embodiments of method 100 provide for measures for a faster and/or more efficient evaluation of the electronic election. For this, the second data processing circuit may comprise a separate first and second evaluation circuit and the distributed ledger database may comprise a first shard indicative of the encrypted vote of the user and a second shard indicative of an encrypted vote of another user. So, the obtaining 140 may comprise obtaining the vote of the user from the first shard using the first evaluation circuit and obtaining the vote of the other user from the second shard using the second evaluation circuit. So, in accordance with the underlying principle of “sharding”, this allows for obtaining the votes of the user and the other user in parallel and, thus, faster than by obtaining their votes one after another using the same data processing circuit. Also, sharding allows to distribute computation capacities for obtaining the votes over several data processing circuits, here the first and the second evaluation circuit. In this context, the first and the second shard can be understood as different horizontal partitions of data in the distributed ledger database. In some embodiments, the first and the second shard may be stored in different storages, e.g., of different constituencies or different public polling terminals. Accordingly, the shards, e.g., store encrypted votes of users who vote in the respective constituencies or used the respective polling terminals. Accordingly, the first and the second evaluation circuit may correspond or comprise computers and/or hardware in the respective constituencies or polling terminals.

Further, method 100 may comprise determining an election result using the obtained vote of the user and the obtained vote of the other user.

It is noted that an establishment, comprising generating 110 the symmetric key and providing 120/130 the symmetric key and the seed, and an evaluation comprising obtaining 140 the user's vote may be executed separately. Accordingly, embodiments of the present disclosure may also provide separate methods for setting up (establishing) the electronic election and evaluating the electronic election as described below.

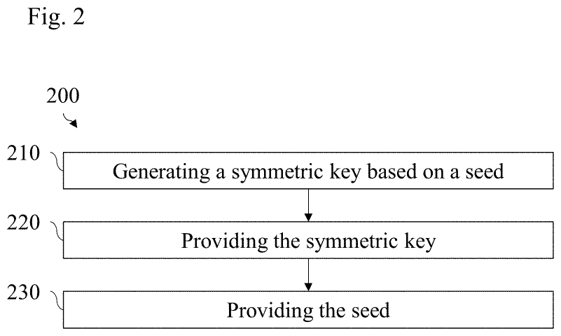

FIG. 2 shows a flow chart schematically illustrating an embodiment of a method 200 for setting up an electronic election. As can be seen from the flow chart, method 200 comprises generating 210, for at least one user, using a TEE, and based on a seed, a symmetric key for encrypting the user's vote with the symmetric key and for entering the encrypted vote in a distributed ledger database. Further, method 200 comprises providing 220 the symmetric key to a first data processing circuit of the user. As well, method 200 comprises providing 230 the seed to at least one second data processing circuit and for obtaining the user's vote from the distributed ledger database by the second data processing circuit using the seed.

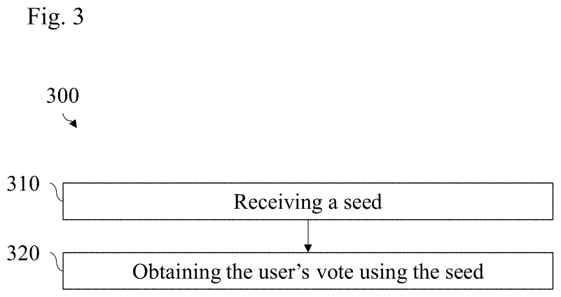

FIG. 3 shows a flow chart schematically illustrating an embodiment of a method 300 for evaluating an electronic election. Method 300 comprises receiving 310 a seed for generating a symmetric key for at least one user based on the seed for voting. Further, method 300 comprises obtaining 320, using the seed, the user's vote from a distributed ledger database, the user's vote being stored as an encrypted vote encrypted with the symmetric key in the distributed ledger database. Referring to method 100, method 300, e.g., is executed by the second data processing circuit explained in connection with method 100.

In particular, methods 200 and 300 may comply with aspects and features of method 100 which relate to the establishment and the evaluation of the electronic election, respectively. It is therefore referred to explanations of method 100 for further details of method 200 and 300.

In embodiments pf the present disclosure, the methods 100, 200, and 300 may be implemented in an apparatus for electronic election.

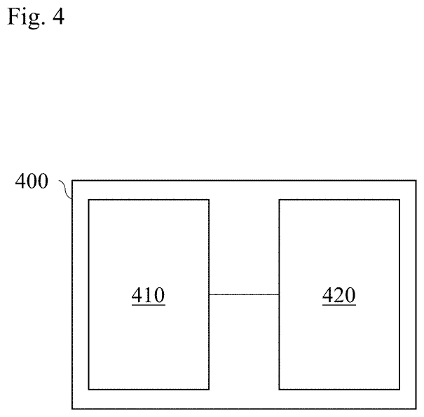

FIG. 4 shows a block diagram schematically illustrating an apparatus 400 for electronic election.

The apparatus comprises one or more interfaces 410 for communicating and processing circuitry 420 configured to control the one or more interfaces 420. The processing circuitry 420 and the one or more interfaces 410 are configured to carry out at least one of the proposed methods 100, 200, and 300.

Accordingly, the TEE and/or the second data processing circuit may be implemented in the processing circuitry. So, although in favor of transparency it may be preferred to implement the TEE and the second data processing circuit in separate circuitries, the TEE and the second data processing circuit may be implemented in the same circuitry, here the processing circuitry. The one or more interfaces, in particular, may be respectively configured for communication between the TEE, the first data processing circuit, and/or the second data processing circuit, respectively.

In embodiments, the one or more interfaces 410 may correspond to or comprise any means for obtaining, receiving, transmitting or providing analog or digital signals or information, e.g. any connector, contact, pin, register, input port, output port, conductor, lane, etc. which allows providing or obtaining a signal or information. An interface may be wireless or wire-line and it may be configured to communicate, i.e. transmit or receive signals, information with further internal or external components. The one or more interfaces 410 may comprise any components to enable according communication between the TEE, the first data processing circuit, and/or the second data processing circuit. Such components may include switches, modems, network devices, Ethernet components, repeaters, hubs, transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, and/or the like. As can be seen form the block diagram, the one or more interfaces 410 are coupled to the processing circuitry 420.

In practice, the processing circuitry 420 may be implemented using one or more processing units, one or more processing devices, any means for processing, such as a processor, a computer or a programmable hardware component being operable with accordingly adapted software. In other words, the described function of the processing circuitry 420 may as well be implemented in software, which is then executed on one or more programmable hardware components. Such hardware components may comprise a general-purpose processor, a Digital Signal Processor (DSP), a micro-controller, and/or the like.

For explanatory purposes, the concept proposed herein is illustrated below by means of an exemplary application.

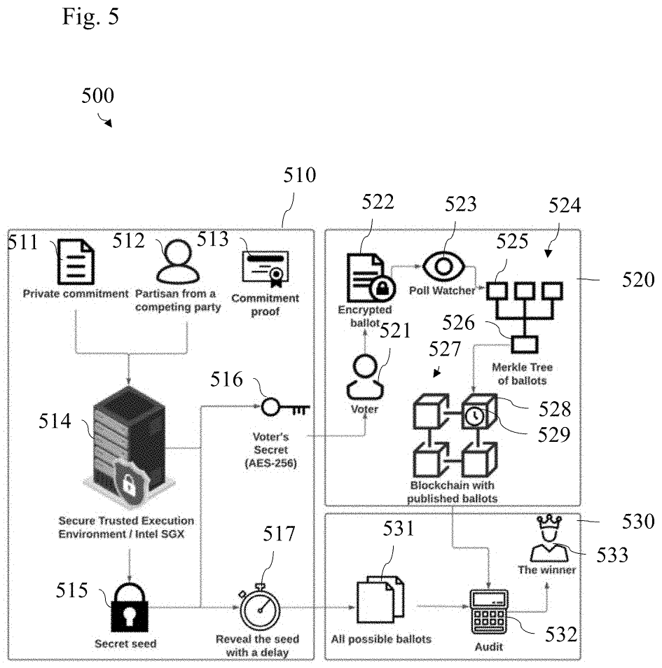

FIG. 5 shows a block diagram 500 schematically illustrating an application of the proposed concept.

As can be seen from block diagram 500, the electronic election may comprise a part 510 relating to the establishment of the electronic election, a part 520 relating to a voting process of the electronic election, and a part 530 relating to the evaluation of the electronic election.

The present exemplary application of the proposed concept provides for registering by parties running for election. In order to do so, partisans 512 from the parties submit private commitments 511 indicative of electronic data to a TEE 514. The private commitments 511, e.g., include a confirmation that a respective party is validly running for election, specific information on a respective party (e.g. names of party members, digital signatures, credentials), and/or a commitment proof 513 indicative of a digital form of a paper certificate of a respective party.

The TEE 514, then, may obtain a seed 515 for generating, based on the seed 515, a symmetric key 516 for a voter 521. For generating the symmetric key 516 e.g., a deterministic pseudorandom number generator (PRNG) or a cryptographically secure PRNG (CSPRNG) is used with the seed 515 as input to the PRNG or the CSPRNG, respectively.

In order to avoid that an already published or known seed is used, the seed 515 may be specifically generated in/inside the TEE 514. Alternatively, the seed 515 may be generated outside the TEE 514. In favor of reliability of the electronic election, the seed 515 may in particular be generated based on election-related data. The election-related data may comprise external input (to the TEE 514), e.g., from a trusted entity (e.g. a party, a voter, or a trusted scrutineer). The election-related data, e.g., is indicative of a start time or a duration of the electronic election, credentials, or information on the trusted entity (e.g. identities of users participating in the electronic election). In the present exemplary application, the election-related data, e.g., comprises the private commitments 511. Optionally, the seed 515 is or comprises a concatenation or transformation of the private commitments 511.

The symmetric key 516, e.g., is configured for the use with the Advanced Encryption Standard 256 (AES-256). Alternatively, the symmetric key 516 may be configured for the use with any one of various other symmetric-key algorithms.

As can be further seen from block diagram 500, the user 521 receives the symmetric key 516 and encrypts his or her vote with the symmetric key 516. For this, the symmetric key 516, e.g., is provided to a personal device or a public polling terminal which is used by the user 521 for voting. The user personal device or the public polling terminal, respectively, may receive the vote from the user 521 and encrypt the user's vote with the symmetric key 516. The encrypted vote, e.g., corresponds to or is comprised of a ballot 522 encrypted with the symmetric key 516 and indicative of how the user 521 voted. So, the encrypted ballot 522 is, e.g., indicative of one of multiple potential choices for which the user could vote. To submit the encrypted ballot 522 and enter the encrypted ballot 522, the user 521 transmits the encrypted ballot 522, using the personal device or the public polling terminal, to a poll watcher 523. The poll watcher 523, e.g., comprises a server configured to communicate with the personal device or the public polling terminal to receive and enter the encrypted ballot 522 in a distributed ledger database, here a blockchain 527. For this, the encrypted ballot 522 may be entered in a block 527 of the blockchain 528. Ideally, there are no disruptions in the operation of the blockchain 527 and in case of the blockchain 527 being a proof-of-work (PoW) blockchain, enough time should be given to eliminate reorgs. In practice, the electronic election may involve one or more other users. In order to save memory of the blockchain 527 and provide scalability for various numbers of users, the exemplary application provides for storing the encrypted ballot 522 together with encrypted votes/encrypted ballots of the other users in respective leaves 525 of a hash tree 524, also referred to as “Merkle tree”, and enter its hash root 526 indicative of the encrypted ballot 522 in block 527 of the blockchain 527. The hash root 526, e.g., is or comprises a concatenation of the leaves 525 and, thus, the encrypted ballot 522. In this way, multiple encrypted ballots/votes may be summarized. In practice, encrypted votes/ballots of users in the same constituency or a pre-defined region may be summarized and entered in the same hash tree. Together with the hash root 526, also a timestamp 529 is entered in the blockchain 527, e.g., in order to determine whether the votes of user 521 and the other users were submitted in time. The timestamp 529 may indicate a time when the votes stored in the hash tree 524 were submitted or entered in the hash tree 524 or when the hash tree 524 was entered in the blockchain 527.

Analogously, also multiple hash roots of hash trees storing encrypted ballots/votes of further users may be stored in the blockchain 527. Optionally, the encrypted ballots/votes or hash roots may be stored in separate horizontal partitions of the blockchain 527 to allow for sharding and, thus, for a larger scalability of the electronic election.

For the evaluation and/or verification of the electronic election, the TEE 515, then, reveals the seed 515. In doing so, the TEE 514, e.g., provides the seed 515 to a data processing circuit in order to grant transparency to said data processing circuit and, e.g., enable it to determine or verify a result of the electronic election using the seed 515. The data processing circuit is, e.g., that of user 521, another user, a scrutineer, the poll watcher, or of another doubtful entity. In practice, the seed 515 may be published and/or provided to a plurality of data processing circuits of doubtful entities.

In particular, the seed 515 may be revealed with a specific delay 517 (e.g., after lapse of a predetermined time) in order to prevent insight into the electronic election using the seed 515 before a specific time, e.g., to prevent illegal insight into the electronic election before the electronic election was closed for voting and, thus, fraudulent election collusions.

For obtaining the vote of user 521 in an audit process 532, the symmetric key 516 of user 521 is reproduced using the seed 515. In order to do so, the same PRNG or CSPRNG may be used with the seed 515 as input to the PRNG or CSPRNG, respectively. The reproduced symmetric key, in turn, allows for “reconstructing” the voting of user 521, e.g., by generating data structures 531 for all potential encrypted votes/ballots, i.e., for each choice for which the user 521 could vote, using the reproduced symmetric key. So, consequently, one of the data structures 531, namely the one based on the actual choice of user 521 in the electronic election, matches with the encrypted ballot 522. So, for obtaining the vote of user 521, the data structures 531 may be compared with the blockchain 527 in order to determine whether and which of the data structures matches with a portion of the blockchain 527 and to obtain the vote of user 521 by the choice used for generating the matching data structure. In the exemplary application, said data structure, e.g., at least partly matches with hash root 526.

In the audit process 532, also the timestamp is retrieved from the blockchain 529 and compared with a predefined time slot where the electronic election was “open” to validly cast votes. So, if the timestamp says that the vote of user 521 was cast within said time slot it is considered valid and counted and invalid otherwise.

In this way, also votes of the one or more other users are obtained in order to determine a result 533 of the electronic election. In order to do so, e.g., a hash table including encrypted ballots/votes of the users (including user 521) is obtained from the blockchain 527 and multiple respective symmetric keys of the users are reproduced in order to iterate through the symmetric keys in the manner described in connection with user 521, e.g., in order to determine a result 533 of the electronic election. The result 533, e.g., indicates shares of the votes for the choices and/or a winning party.

The effort for determining the result 533 particularly increases with the number of users participating in the electronic election. For n users, e.g., it takes O(n) operations for determining the result 533. In order to parallelize the operations, sharding may be applied. For this, the blockchain 527 may comprise a first shard (e.g. a first horizontal partition) storing encrypted ballots of a first portion of users (e.g. including user 521) and a second shard (e.g. a second horizontal partition) storing encrypted ballots/votes of a second portion of users. In doing so, the votes of the first portion of users may be obtained from the first shard using a first evaluation circuit while in parallel the votes of the second portion of users may be obtained from the second shard using a second evaluation circuit. Then, the result of the electronic election may be determined using the obtained using the votes obtained from the first and second shard. In some embodiments, this is analogously applied to more than two shards for a faster evaluation of the electronic election.

Further embodiments pertain to:

(1) A method for electronic election, the method comprising:
generating, by a trusted execution environment, TEE, a symmetric key for at least one user based on a seed;
providing, by the TEE, the symmetric key to a first data processing circuit of the user for encrypting the user's vote with the symmetric key and entering the encrypted vote in a distributed ledger database;
providing, by the TEE, the seed to at least one second data processing circuit; and
obtaining, by the second data processing circuit, the user's vote from the distributed ledger database using the seed.

(2) The method of (1), obtaining the user's vote from the distributed ledger database comprising:
reproducing the symmetric key using the seed;
generating, using the reproduced symmetric key, data structures for one or more potential encrypted votes of the user; and
comparing the data structures with the distributed ledger database for obtaining the user's vote from one of the data structures which matches with the encrypted vote.

(3) The method of (1) or (2), the method further comprising:
receiving election-related data; and
generating the seed based on the election-related data.

(4) The method of any one of (1) to (3), the seed being provided to the second data processing circuit after lapse of a predetermined time.

(5) The method of any one of (1) to (4), the second data processing circuit comprising a separate first and second evaluation circuit and the distributed ledger database comprising a first shard indicative of the encrypted vote of the user and a second shard indicative of an encrypted vote of another user, obtaining the user's vote comprising obtaining the vote of the user from the first shard using the first evaluation circuit and obtaining the vote of the other user from the second shard using the second evaluation circuit, and the method further comprising determining an election result using the obtained vote of the user and the obtained vote of the other user.

(6) A method for setting up an electronic election, the method comprising:
generating, for at least one user, using a trusted execution environment, TEE, and based on a seed, a symmetric key for encrypting the user's vote with the symmetric key and for entering the encrypted vote in a distributed ledger database;
providing the symmetric key to a first data processing circuit of the user; and
providing the seed to at least one second data processing circuit and for obtaining the user's vote from the distributed ledger database by the second data processing circuit using the seed.

(7) The method of (6), the method further comprising:
receiving election-related data; and
generating the seed based on the election-related data.

(8) The method of (6) or (7), the seed being provided to the second data processing circuit after lapse of a predetermined time.

(9) The method of any one of (6) to (8), generating the symmetric key comprising:
obtaining information related to the user; and
generating an individual symmetric key for the user based on the information related to the user.

(10) A method for evaluating an electronic election, the method comprising:
receiving a seed for generating a symmetric key for at least one user based on the seed for voting; and
obtaining, using the seed, the user's vote from a distributed ledger database, the user's vote being stored as an encrypted vote encrypted with the symmetric key in the distributed ledger database.

(11) The method of (10), the distributed ledger database comprising a hash root indicative of a hash tree including the encrypted vote, and obtaining the user's vote comprising obtaining, using the seed, the user's vote from the hash root.

(12) The method of (10) or (11), obtaining the user's vote comprising:
reproducing the symmetric key using the seed;
generating, using the reproduced symmetric key, data structures for one or more potential encrypted votes of the user; and
comparing the data structures with the distributed ledger database for obtaining the user's vote from one of the data structures which matches with the encrypted vote.

(13) The method of any one of (10) to (12), the distributed ledger database further storing a timestamp indicating a time when the user submitted the vote, and the method further comprising:
obtaining the timestamp from the distributed ledger database; and
checking whether the user submitted the vote within a predefined time slot.

(14) The method of any one of (10) to (13), the method further comprising evaluating the electronic election using the obtained vote.

(15) The method of any one of (10) to (14), the distributed ledger database comprising a first shard indicative of a first encrypted vote of a first user and a second shard indicative of a second shard indicative of a second encrypted vote of a second user, and obtaining the user's vote comprising obtaining the vote of the first user from the first shard using a first evaluation circuit and obtaining the vote of the second user from the second shard using a second evaluation circuit, and the method further comprising evaluating the electronic election using the obtained first and second vote.

(16) A computer program having a program code for performing a method according to any one of (1) to (15) when the program is executed on a processor or a programmable hardware.

(17) A non-transitory machine-readable medium having stored thereon a program having a program code for performing the method of any one of (1) to (15), when the program is executed on a processor or a programmable hardware.

(18) An apparatus for electronic election, the apparatus comprising:
one or more interfaces for communicating; and
processing circuitry configured to control the one or more interfaces, the processing circuitry and the one or more interfaces being configured to carry out a method of any one of (1) to (15).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for electronic election, the method comprising:
generating, by a trusted execution environment, TEE, a symmetric key for at least one user based on a seed;
providing, by the TEE, the symmetric key to a first data processing circuit of the user for encrypting the user's vote with the symmetric key and entering the encrypted vote in a distributed ledger database;
providing, by the TEE, the seed to at least one second data processing circuit; and
obtaining, by the second data processing circuit, the user's vote from the distributed ledger database using the seed.

2. The method of claim 1, obtaining the user's vote from the distributed ledger database comprising:
reproducing the symmetric key using the seed;
generating, using the reproduced symmetric key, data structures for one or more potential encrypted votes of the user; and
comparing the data structures with the distributed ledger database for obtaining the user's vote from one of the data structures which matches with the encrypted vote.

3. The method of claim 1, the method further comprising:
receiving election-related data; and
generating the seed based on the election-related data.

4. The method of claim 1, the seed being provided to the second data processing circuit after lapse of a predetermined time.

5. The method of claim 1, the second data processing circuit comprising a separate first and second evaluation circuit and the distributed ledger database comprising a first shard indicative of the encrypted vote of the user and a second shard indicative of an encrypted vote of another user, obtaining the user's vote comprising obtaining the vote of the user from the first shard using the first evaluation circuit and obtaining the vote of the other user from the second shard using the second evaluation circuit, and the method further comprising determining an election result using the obtained vote of the user and the obtained vote of the other user.

6. A method for setting up an electronic election, the method comprising:
generating, for at least one user, using a trusted execution environment, TEE, and based on a seed, a symmetric key for encrypting the user's vote with the symmetric key and for entering the encrypted vote in a distributed ledger database;
providing the symmetric key to a first data processing circuit of the user; and
providing the seed to at least one second data processing circuit and for obtaining the user's vote from the distributed ledger database by the second data processing circuit using the seed.

7. The method of claim 6, the method further comprising:
receiving election-related data; and
generating the seed based on the election-related data.

8. The method of claim 6, the seed being provided to the second data processing circuit after lapse of a predetermined time.

9. The method of claim 6, generating the symmetric key comprising:
obtaining information related to the user; and
generating an individual symmetric key for the user based on the information related to the user.

10. A method for evaluating an electronic election, the method comprising:
receiving a seed for generating a symmetric key for at least one user based on the seed for voting; and
obtaining, using the seed, the user's vote from a distributed ledger database, the user's vote being stored as an encrypted vote encrypted with the symmetric key in the distributed ledger database.

11. The method of claim 10, the distributed ledger database comprising a hash root indicative of a hash tree including the encrypted vote, and obtaining the user's vote comprising obtaining, using the seed, the user's vote from the hash root.

12. The method of claim 10, obtaining the user's vote comprising:
reproducing the symmetric key using the seed;
generating, using the reproduced symmetric key, data structures for one or more potential encrypted votes of the user; and
comparing the data structures with the distributed ledger database for obtaining the user's vote from one of the data structures which matches with the encrypted vote.

13. The method of claim 10, the distributed ledger database further storing a timestamp indicating a time when the user submitted the vote, and the method further comprising:
obtaining the timestamp from the distributed ledger database; and
checking whether the user submitted the vote within a predefined time slot.

14. The method of claim 10, the method further comprising evaluating the electronic election using the obtained vote.

15. The method of claim 10, the distributed ledger database comprising a first shard indicative of a first encrypted vote of a first user and a second shard indicative of a second shard indicative of a second encrypted vote of a second user, and obtaining the user's vote comprising obtaining the vote of the first user from the first shard using a first evaluation circuit and obtaining the vote of the second user from the second shard using a second evaluation circuit, and the method further comprising evaluating the electronic election using the obtained first and second vote.

16. A computer program having a program code for performing a method according to claim 1, when the program is executed on a processor or a programmable hardware.

17. A non-transitory machine-readable medium having stored thereon a program having a program code for performing a method according to claim 1, when the program is executed on a processor or a programmable hardware.

18. An apparatus for electronic election, the apparatus comprising:
one or more interfaces for communicating; and
processing circuitry configured to control the one or more interfaces, the processing circuitry and the one or more interfaces being configured to carry out a method according to claim 1.
